(19) United States
(12) Patent Application Publication
(10) Pub. No.: US 2023/0106243 A1
(43) Pub. Date: Apr. 6, 2023

(54) LIQUID DEGASSING DEVICE

(71) Applicant: Service Support Specialties, Inc., Montville, NJ (US)

(72) Inventors: Gary HILLMAN, Livingston, NJ (US); Jayant Chandrakant BHOSLE, Harrison, NJ (US); Cody WALTERS, Vernon, NJ (US)

(21) Appl. No.: 17/941,635

(22) Filed: Sep. 9, 2022

Related U.S. Application Data
(60) Provisional application No. 63/248,121, filed on Sep. 24, 2021.

(51) Int. Cl. B01D 19/00

(52) U.S. Cl. CPC B01D 19/0042

(57) ABSTRACT

Devices for separating gas and liquid components from a fluid are used in a wide variety of processes. These devices may be formed of a housing having a cavity, an inlet, an outlet, and a vent. A diversion structure may be located within the cavity of the housing to allow fluid to flow in a convoluted path which promotes separation of the gas and liquid components. The device may be used in semiconductor fabrication processes or any other processes which require gas-free liquids.

### CROSS REFERENCE TO RELATED APPLICATIONS

This application claims the benefit of U.S. Provisional Application 63/248,121, filed Sep. 24, 2021, which is incorporated herein by reference in its entirety.

### BACKGROUND OF THE INVENTION

Semiconductor and other related industries utilize liquids in cleaning and other processes. These liquids must be free of gases to the maximum extent possible to avoid undesired reactions, ensure effectiveness of the respective processes, and ensure that the entire surface of a wafer or other substrate is treated with the process liquid. Liquid degassing devices are utilized to ensure that the liquids are free of gases such as air or nitrogen. However, conventional liquid degassing devices are large, expensive, and limited in the velocity of liquid flow therethrough. Thus, a need exists for devices that address the aforementioned deficiencies.

### SUMMARY OF THE INVENTION

The present technology is directed to a degassing device for use in a process utilizing a fluid. The process may utilize a liquid and may require that liquid be free of dissolved gases.

In one implementation, the invention may be a degassing device. The degassing device has a housing, an inlet, a vent, an outlet, and a diversion structure. The housing has a cavity. The inlet extends through the housing to the cavity. The inlet is configured to receive a fluid. The vent also extends through the housing. The vent is configured to output a gas component separated from the fluid. The outlet extends through the housing to the cavity. The outlet is configured to output a liquid component separated from the fluid. The diversion structure is mounted within the cavity. The diversion structure has an open top end, a closed bottom end, an upstanding wall extending from the open top end to the closed bottom end, and a cavity formed by the open top end, the closed bottom end, and the upstanding wall. The inlet is configured to direct the fluid into the cavity of the diversion structure via the open top end, the liquid component of the fluid exiting the cavity of the diversion structure via the open top end and flowing around the diversion structure to the outlet.

In another implementation, the invention may be a degassing device. The degassing device has a housing, an inlet, a vent, an outlet, a flow path, and a diversion structure. The housing has a cavity. The inlet extends through the housing to the cavity. The inlet is configured to receive a fluid. The vent also extends through the housing. The vent is configured to output a gas component separated from the fluid. The outlet extends through the housing to the cavity. The outlet is configured to output a liquid component separated from the fluid. The flow path extends from the inlet to the outlet. The diversion structure is mounted within the cavity. The diversion structure has an open top end, a closed bottom end, an upstanding wall extending from the open top end to the closed bottom end, and a cavity formed by the open top end, the closed bottom end, and the upstanding wall. The device is configured to guide the liquid component of the fluid in an S-shaped path from the inlet to the outlet.

In an alternate implementation, the invention may be a method of removing gas from a fluid. In a first step, a stream of fluid is flowed through an inlet of a degassing device, the degassing device comprising a housing comprising a cavity. Next, the stream of the fluid is directed into a cavity of a diversion structure located within the cavity of the housing. Subsequently, the diversion structure redirects the stream of the fluid such that the fluid reverses direction and flows in a first direction toward the inlet and out of the cavity of the diversion structure. Then the direction of the stream of the fluid reverses such that a liquid component flows in a second direction opposite the first direction, a gas component continuing in the first direction. Finally, the liquid component is flowed out of the cavity of the housing via an outlet.

Further areas of applicability of the present technology will become apparent from the detailed description provided hereinafter. It should be understood that the detailed description and specific examples, while indicating the preferred implementation, are intended for purposes of illustration only and are not intended to limit the scope of the technology.

### BRIEF DESCRIPTION OF THE DRAWINGS

The present invention will become more fully understood from the detailed description and the accompanying drawings, wherein:

FIG. 1 is a perspective view of a degassing device according to the present invention;

FIG. 2 is a top view of the degassing device as shown in FIG. 1;

FIG. 3 is a front view of the degassing device as shown in FIG. 1;

FIG. 4 is a right view of the degassing device as shown in FIG. 1;

FIG. 5 is a right view of the degassing device as shown in FIG. 1;

FIG. 6 is a cross-section view of the degassing device taken along the line XI-XI of FIG. 2;

FIG. 7 is a cross-section view of the degassing device taken along the line XII-XII of FIG. 2; and

FIG. 8 is an exploded view of the degassing device as shown in FIG. 1.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” ”up,” “down,” “top” and “bottom” as well as derivatives thereof (e.g., “horizontally,” ”downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

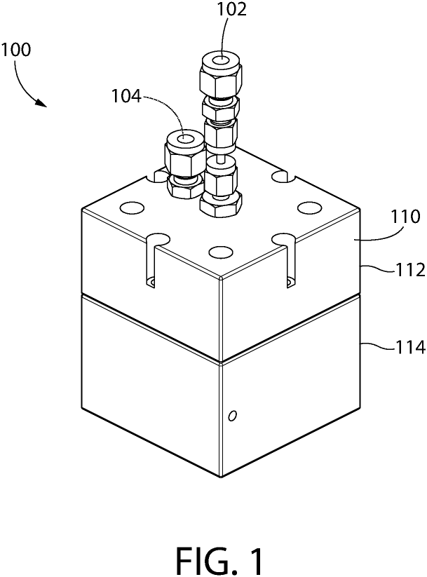

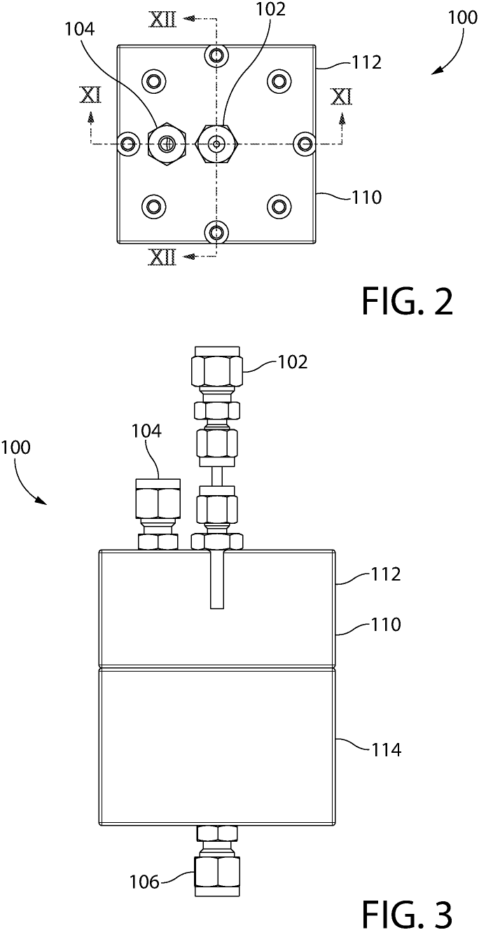

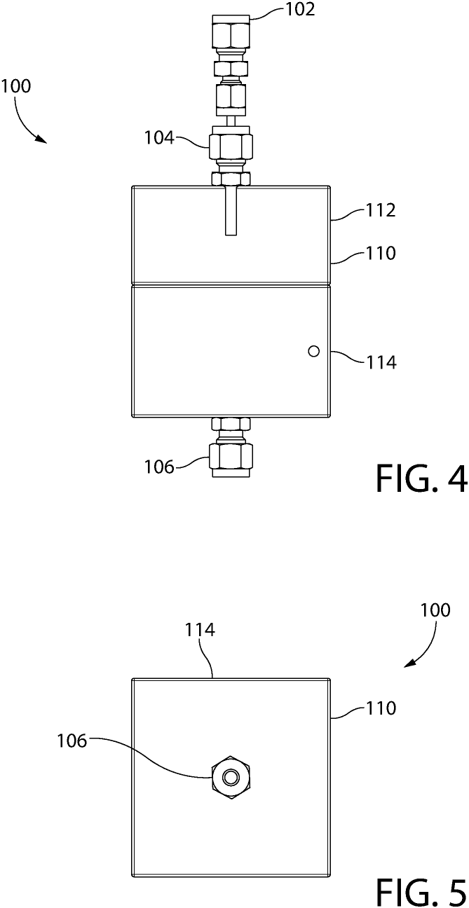

FIGS. 1-5 illustrate a perspective view of a degassing device 100 for removing gas from a flow of a fluid. Preferably, the fluid comprises a liquid component and a gas component, the liquid component being a majority of the fluid. The gas component is typically dissolved gas within the liquid component. The device 100 has an inlet 102, a vent 104, and an outlet 106. The inlet 102 receives a flow of the fluid. Within the device 100, gas is separated from the fluid, with the gas being vented via the vent 104. The inlet 102, vent 104, and outlet 106 are all formed such that they extend through a housing 110. The housing 110 has an upper portion 112 and a lower portion 114 that are secured together with fasteners. Optionally, the housing 110 may be joined via welding, gluing, or other methods known in the art. While the housing 110 is depicted with a square or box-like shape, the invention is not to be so limited and the housing 110 may take on other desired shapes, including being cylindrical, conical, pyramid shaped, or the like.

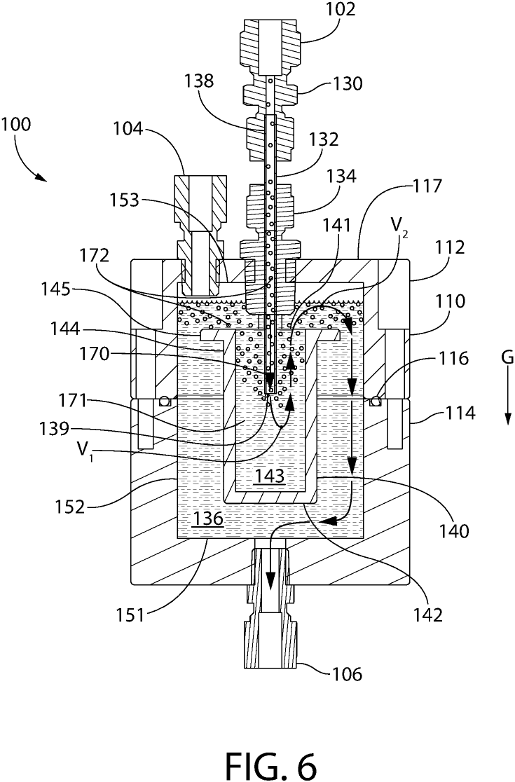

Turning to FIG. 6, a cross-sectional view of the device 100 is shown. As can be seen, the inlet 102 comprises a first fitting 130, an inlet tube 132, and a second fitting 134. The inlet tube 132 extends from the first fitting 130 through the second fitting 134 to a cavity 136 formed by the housing 110. The inlet tube 132 may optionally comprise a constriction or flow restriction. Optionally, a separate constriction or flow restriction may be formed elsewhere in a flow path fluidly coupled to the inlet 102. For instance, the flow restriction may be located at one of the fittings 130, 134 of the inlet 102 or upstream of the inlet 102. Optionally, the flow restriction may be at a position between the first fitting 130 and the cavity 136 if the inlet tube 132 does not extend completely into the cavity 136. In yet other embodiments, the inlet tube 132 may form the flow restriction.

The inlet tube 132 extends from a first end 138 outside the housing 110 to a second end 139 within the cavity 136 of the housing 110. The second end 139 of the inlet tube 132 extends into a diversion structure 140. The diversion structure 140 has an open top end 141, a closed bottom end 142, a cavity 143, and an upstanding wall 144 extending from the open top end 141 to the closed bottom end 142. The upstanding wall 144 and the closed bottom end 142 form the cavity 143. The diversion structure 140 may be of any desired shape and may or may not include a flange 145 to enable mounting the diversion structure 140 within the housing 110. Optionally, other features may be incorporated into the diversion structure 140 to enable mounting the diversion structure 140 within the housing 110.

The housing 110 comprises an upper surface 117 and an opposite lower surface 118. The inlet 102 extends through the upper surface 117 to the cavity 136 of the housing 110. Similarly, the vent 104 extends through the upper surface 117 to the cavity 136. The outlet 106 extends through the lower surface 118 to the cavity 136. The outlet 106 may extend through the sidewall of the housing 110 which extends between the upper and lower surfaces 118 in other embodiments. In particular, the outlet 106 may be located in alignment with the floor of the housing 110, but through the sidewall instead of through the lower surface 118.

The diversion structure 140 is positioned within the cavity 136 of the housing such that it is spaced from a bottom wall 151, upstanding walls 152, and a top wall 153 of the cavity 136. The second end 139 of the inlet tube 132 extends below the open top end 141 of the diversion structure 140. The diversion structure 140 is spaced from the walls 151, 152, 153 of the cavity 136, ensuring that a flow path exists between the second end 139 of the inlet tube 132 and the outlet 106. Furthermore, the lower portion 114 and the upper portion 112 of the housing 110 are sealed by an O-ring 116 which is inserted into O-ring grooves formed into the mating surfaces of the upper and lower portions 112, 114. The O-ring 116 provides a liquid and gas tight connection and ensures that no fluid can escape the housing 110 except at the outlet 106.

The device 100 is preferably oriented such that the inlet 102 directs fluid downward with respect to a gravity vector G. Otherwise stated, the inlet 102 is directed downward such that gravity accelerates the fluid downward absent an outside force. Thus, a stream 170 of the fluid which emits from the inlet 102 moves along the gravity vector G until it enters the open top end 141 of the diversion structure 140. Within the cavity 143 of the diversion structure 140, the fluid stream 170 achieves zero downward velocity at a first zero velocity point V₁. Subsequently, the fluid stream 170 is redirected within the cavity 143 and flows upward in a first direction, away from the closed bottom end 142 of the diversion structure 140. The first direction is opposite the gravity vector G and back towards the inlet 102. The first direction is substantially parallel to the gravity vector G.

As the stream 170 flows upward, gas and liquid components 172, 171 of the fluid begin to separate. The gas component 172 continues in the first direction and is ultimately vented from the vent 104. The liquid component 171 again reverses direction and achieves zero upward velocity at a second zero velocity point V₂. Finally, the liquid component 171 flows in a second direction substantially parallel to the gravity vector G until it flows out of the outlet 106. Thus, the liquid component 171 flows over the open top end 141 of the diversion structure 140 and then downward and out of the outlet 106. As can be seen, the flow path of the liquid component 171 of the stream 170 is generally S-shaped from the inlet 102 to the outlet 106.

In one method of use, fluid is flowed through the inlet 102 under pressure. As the fluid flows past a constriction provided in the inlet tube 132, the pressure in the fluid drops. This causes dissolved gases to separate from the liquid. The liquid and gases exit the second end 139 of the inlet tube 132 into the cavity 143 of the diversion structure 140. The gases form bubbles in the liquid as a result of the drop in pressure. The liquid and gas mixture then flows downward toward the closed bottom end 142 of the diversion structure 140. The gas bubbles and the liquid are forced to reverse direction, completely eliminating any downward velocity. The gas bubbles and the liquid then flow upward around the second end 139 of the inlet tube 132 and out over the top of the open top end 141 of the diversion structure 140. In the process, the gas bubbles and the liquid have an upward velocity. The liquid flows over the top flange 145 of the diversion structure and then again reverses direction, flowing downward toward the outlet 106. Meanwhile, the gas bubbles continue upward, separating from the liquid and coming to rest adjacent the top wall 153 of the cavity 136 of the housing 110. Gas can be continuously or periodically vented from the vent 104, ensuring that none of the gas which is separated from the liquid flow is re-dissolved and the liquid is free of dissolved gases.

The device 100 achieves efficient separation of gas from a flow of liquid by forcing the liquid through the constriction in the inlet tube 132 to reduce the pressure of the liquid and increase the velocity of the liquid. This, in combination with the downward velocity imparted by directing the flow of liquid toward the closed bottom end 142 of the diversion structure 140 results in two changes of direction for the liquid and gas flow. This results in improved separation of the gas bubbles from the liquid without the need for large cavity volumes to allow the gas and liquid to separate. Each change of direction of the liquid flow results in the gas bubbles and liquid flow achieving zero velocity, enhancing the separation effects provided by the differences in density. Gas is more effectively separated and the total volume of the chamber is reduced.

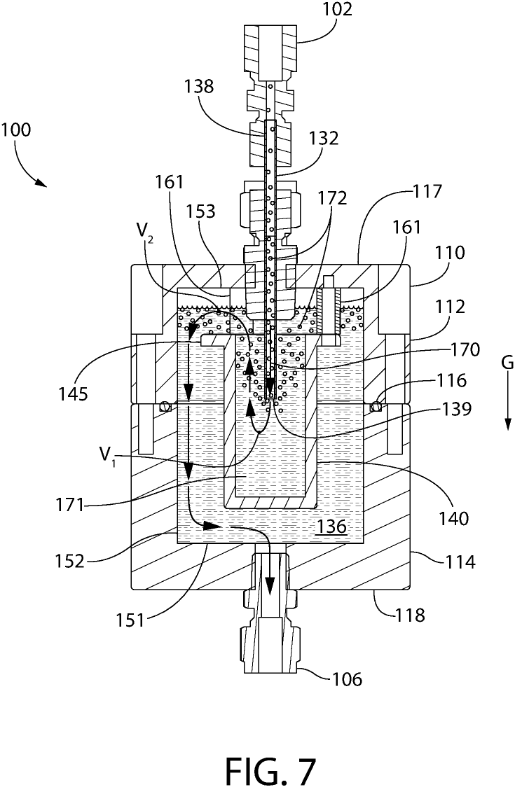

Turning to FIG. 7, another cross-section view of the device 100 is shown. The inlet 102 and outlet 106 are illustrated, along with the diversion structure 140 and the cavity 136 of the housing 110. The diversion structure 140 is joined to the upper portion 112 of the housing 110 via standoffs 161. These standoffs 161 engage the flange 145 so that the diversion structure 140 is spaced from the walls 151, 152, 153 of the cavity 136 of the housing 110. Any other method known in the art may be used, including engagement features between the flange 145 and the housing 110 so long as fluid is free to flow from the open top end 141 of the diversion structure 140 to the outlet 106.

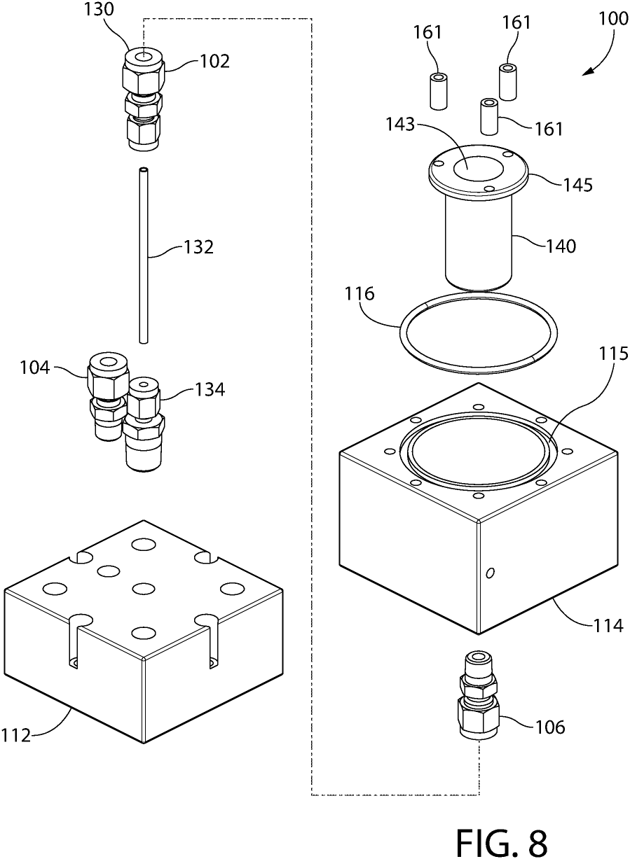

FIG. 8 illustrates the device 100 in exploded view. The inlet 102 comprises the first fitting 130, inlet tube 132, and second fitting 134. The first fitting 130 receives a tube which supplies the fluid from an external device such as a valve. Optionally, the inlet 102 may be integrated into the housing of another component to reduce mechanical complexity and reduce costs. The second fitting 134 installs into the upper portion 112 of the housing 110 and the inlet tube 132 extends through the second fitting 134 into the cavity 136 as discussed above. More specifically, the inlet tube 132 extends into the cavity 143 of the diversion structure 140, the diversion structure 140 being located within the cavity 136 of the housing 110. The vent 104 is another fitting which may accept a tube, the fitting being installed into the upper portion 112 of the housing 110. Finally, the outlet 106 is yet another fitting which may accept a tube, the fitting being installed in the lower portion 114 of the housing 110.

A plurality of standoffs 161 engage the flange 145 of the diversion structure 140 and the upper portion 112 of the housing 110 to position the diversion structure 140 within the cavity 136 of the housing 110. The O-ring 116 is shown, the O-ring 116 located within an O-ring groove 115 in the lower portion 114 of the housing 110 to provide a seal between the upper and lower portions 112, 114 of the housing. Optionally, the upper portion 112 may also comprise an O-ring groove, or only one of the upper and lower portions 112, 114 may incorporate an O-ring groove or other O-ring locating feature.

While the invention has been described with respect to specific examples including presently preferred modes of carrying out the invention, those skilled in the art will appreciate that there are numerous variations and permutations of the above described systems and techniques. It is to be understood that other embodiments may be utilized, and structural and functional modifications may be made without departing from the scope of the present invention. Thus, the spirit and scope of the invention should be construed broadly as set forth in the appended claims.

1. A degassing device, the device comprising:
a housing, the housing comprising a cavity;
an inlet extending through the housing to the cavity, the inlet configured to receive a fluid;
a vent extending through the housing to the cavity, the vent configured to output a gas component separated from the fluid;
an outlet extending through the housing to the cavity, the outlet configured to output a liquid component separated from the fluid;
a diversion structure mounted within the cavity, the diversion structure comprising an open top end, a closed bottom end, an upstanding wall extending from the open top end to the closed bottom end, and a cavity formed by the open top end, the closed bottom end, and the upstanding wall;
wherein the inlet is configured to direct the fluid into the cavity of the diversion structure via the open top end, the liquid component of the fluid exiting the cavity of the diversion structure via the open top end and flowing around the diversion structure to the outlet.

2. The device of claim 1 wherein the inlet comprises a flow restriction.

3. The device of claim 1 wherein the inlet directs a stream of the fluid downward with respect to a gravity vector.

4. The device of claim 3 wherein the stream of the fluid reverses direction within the cavity of the diversion structure, flowing upward with respect to the gravity vector; and wherein the liquid component of the fluid reverses direction a second time to flow from the cavity of the housing via the outlet.

5. (canceled)

6. The device of claim 1 wherein the device is configured to guide the liquid component of the fluid in an S-shaped path from the inlet to the outlet.

7. The device of claim 1 wherein the housing comprises an upper surface and an opposite lower surface, the inlet extending through the upper surface of the housing; and wherein the vent extends through the upper surface of the housing.

8. (canceled)

9. (canceled)

10. The device of claim 1 wherein the liquid component of the fluid has a first zero velocity point located within the cavity of the diversion structure and a second zero velocity point located within the cavity of the housing but outside of the cavity of the diversion structure.

11. A degassing device, the device comprising:
a housing, the housing comprising a cavity;
an inlet extending through the housing to the cavity, the inlet configured to receive a fluid;
a vent extending through the housing to the cavity, the vent configured to output a gas component separated from the fluid;
an outlet extending through the housing to the cavity, the outlet configured to output a liquid component separated from the fluid;
a flow path extending from the inlet to the outlet;
a diversion structure mounted within the cavity, the diversion structure comprising an open top end, a closed bottom end, an upstanding wall extending from the open top end to the closed bottom end, and a cavity formed by the open top end, the closed bottom end, and the upstanding wall;
wherein the device is configured to guide the liquid component of the fluid in an S-shaped path from the inlet to the outlet.

12. The device of claim 11 wherein the inlet is configured to direct the fluid into the cavity of the diversion structure via the open top end, the liquid component of the fluid exiting the cavity of the diversion structure via the open top end and flowing around the diversion structure to the outlet.

13. The device of claim 11 wherein the inlet comprises a flow restriction.

14. The device of claim 11 wherein the inlet directs a stream of the fluid downward with respect to a gravity vector; wherein the stream of the fluid reverses direction within the cavity of the diversion structure, flowing upward with respect to the gravity vector; and wherein the liquid component of the fluid reverses direction a second time to flow from the cavity of the housing via the outlet.

15. (canceled)

16. (canceled)

17. The device of claim 11 wherein the housing comprises an upper surface and an opposite lower surface, the inlet extending through the upper surface of the housing; and wherein the outlet extends through the lower surface of the housing.

18. (canceled)

19. (canceled)

20. The device of claim 11 wherein the liquid component of the fluid has a first zero velocity point located within the cavity of the diversion structure and a second zero velocity point located within the cavity of the housing but outside of the cavity of the diversion structure.

21. A method of removing gas from a fluid, the method comprising:
flowing a stream of a fluid through an inlet of a degassing device, the degassing device comprising a housing comprising a cavity;
directing the stream of the fluid into a cavity of a diversion structure located within the cavity of the housing;
redirecting, via the diversion structure, the stream of the fluid such that the fluid reverses direction and flows in a first direction toward the inlet and out of the cavity of the diversion structure;
reversing the direction of the stream of the fluid such that a liquid component flows in a second direction opposite the first direction, a gas component continuing in the first direction; and
flowing the liquid component out of the cavity of the housing via an outlet.

22. The method of claim 21 wherein the first direction is opposite a gravity vector.

23. The method of claim 21 wherein, subsequent to the step of reversing, the gas component of the fluid is vented from the cavity of the housing via a vent.

24. The method of claim 21 wherein the liquid component of the fluid flows in an S-shaped path from the inlet to the outlet.

25. The method of claim 21 wherein, in the step of flowing, the stream is directed through a flow restriction.

26. The method of claim 21 wherein, in the step of flowing, the stream is directed downward with respect to a gravity vector.

27. The method of claim 21 wherein, in the step of redirecting, the stream has zero velocity at a first zero velocity point; and wherein, in the step of reversing, the liquid component has zero velocity at a second zero velocity point.

28. (canceled)
